(19) United States
(12) Patent Application Publication
(10) Pub. No.: US 2020/0004220 A1
(43) Pub. Date: Jan. 2, 2020

(54) METHOD AND APPARATUS FOR PERFORMING AN AUTOMATIC HEALTH CHECKUP FOR A CNC TURNING CENTER

(71) Applicant: Siddhant Sarup, Ludhiana, Punjab (IN)

(72) Inventors: Siddhant Sarup, Ludhiana, Punjab (IN); Gaurav Sarup, Ludhiana, Punjab (IN); Prashant Sarup, Ludhiana, Punjab (IN)

(73) Assignee: Siddhant Sarup, Ludhiana, Punjab (IN)

(21) Appl. No.: 16/486,518

(22) PCT Filed: Feb. 23, 2018
(86) PCT No.: PCT/IN2018/050097

§ 371 Date: Aug. 16, 2019

(30) Foreign Application Priority Data
Feb. 24, 2017 (IN) 201711002737

(51) Int. Cl. G05B 19/4063; G05B 19/4062; G05B 19/4065

(52) U.S. Cl. CPC G05B 19/4063; G05B 19/4065; G05B 19/4062

(57) ABSTRACT

The present invention relates to method and apparatus for performing a health checkup of a CNC turning center. The present invention relies on a plurality of inputs to measure the health of the CNC turning center. These inputs include a) Vibration b) Currents drawn by Servo motors & machine spindle. Whenever the CNC turning center is powered up, a health check-up mechanism is performed and appropriate corrective measures are taken if required.

### FIELD OF THE INVENTION

The present invention relates to computerized numerical control (CNC) machines and in particularly relates to method and apparatus for performing a health check-up of a CNC turning center and taking appropriate corrective measures if required.

### BACKGROUND OF THE INVENTION

A machine tool generally refers to a tool that is controlled by servo motors to move in a linear or rotational manner based on several coordinates such as the standard x-axis, y-axis and z-axis coordinates. Various types of machine tools, such as mills, lathes, drills, grinders, welding machines and routers that were once operated by a trained engineer have, in many cases, been replaced by a machine tool that has been coupled to a dedicated computer numerical controller (CNC). A CNC provides specific instructions to the machine tool components enabling them to complete a specific process such as drilling a hole in a piece of metal stock at a particular x-axis, y-axis and z-axis coordinate. This type of CNC controlled machine tool is generally referred to as a CNC turning center. CNC machines provide many benefits in industrial applications as they can be used continuously 24 hours a day, 365 days a year and only need to be switched off for occasional maintenance. Additionally, once a CNC turning center is programmed to make a particular part, it can then manufacture hundreds or even thousands of the same part and each manufactured product will be exactly the same.

CNCs range in capability from providing simple point-to-point linear control to providing multiple axis control using highly complex algorithms. A CNC machine will typically have an interface for use by an operator that provides a standard set of commands that can be selected by the operator, and that additionally allows the operator to enter modifying data such as work, tool and geometric offsets. When a tool offset is required, for example due to wear on the tool surface, the operator typically enters offset adjustments into the CNC and then visually verifies that the tool is in the correct position by looking at the tool. This process of offsetting the tool is rather cumbersome and often requires multiple attempts to properly align the tool. The methods used are arbitrary and dependent on human judgement. There exists a long felt need for a method of automatic checking health of CNC turning center that is not arbitrary and reduces dependency on human judgement.

### SUMMARY OF THE INVENTION

In an embodiment, a method for performing an automatic health check-up for a CNC turning center is provided. The method comprises the steps of:
receiving a signal signalling switching ON of said CNC turning center;
performing a measurement check-up to collect measurement data values relating to one or more servo motors and one or more spindle motors, wherein said performing includes:
   measuring currents drawn by said one or more servo motors at a predetermined feed rate in a particular direction;
   measuring currents drawn by said one or more spindle motors at a plurality of different RPMs;
   measuring the vibrations in the spindle bearings at a plurality of different RPMs;
   comparing collected measurement data values relating to said one or more servo motors and said one or more spindle motors respectively with pre-stored data values relating to said one or more servo motors and said one or more spindle motors respectively;
   ascertaining status/level of one or more parts of said CNC turning center based on said comparing, said status/level indicating service quality level of one or more parts of said CNC turning center;
   triggering an action to be performed in respect of said CNC turning center based on ascertained status/level.

In another embodiment, an apparatus for performing an automatic health check-up for a CNC turning center is provided. The apparatus comprises:
a receiver for receiving a signal signalling switching ON of said CNC turning center;
a controlling unit configured to collect measurement data values relating to one or more servo motors and one or more spindle motors,
a first current measuring unit for measuring currents drawn by said one or more servo motors at a pre-determined feed rate in a particular direction;
a second current measuring unit for measuring currents drawn by said one or more spindle motors at a plurality of different RPMs;
a vibration sensing unit for measuring the vibrations in the spindle bearings at a plurality of different RPMs;
a processing unit for:
   comparing collected measurement data values relating to said one or more servo motors and said one or more spindle motors respectively with pre-stored data values relating to said one or more servo motors and said one or more spindle motors respectively; and
   ascertaining status/level of one or more parts of said CNC turning center based on said comparing, said status/level indicating service quality level of one or more parts of said CNC turning center; and
   a triggering unit for triggering one or more actions to be performed in respect of said CNC turning center based on ascertained status/level.

An object of the present invention is to ensure that the human judgement in checking the quality level of the CNC turning center is minimized.

An object of the present invention is to ensure that the CNC machines can be run by humans with minimal defects.

An object of the present invention is to ensure that the dependency on humans for testing is minimized.

An object of the present invention is to provide information of the defects in CNC turning centre to proper personnel on a timely basis and take appropriate corrective measures.

An object of the present invention is to provide a reliable, automatic method for accident detection and automatic action initiation for CNC Turning Centres.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present invention will become better understood when the following detailed description is read with reference to the accompanying drawings in which like characters represent like parts throughout the drawings, wherein:

FIG. 1 shows a flow chart for a method for performing an automatic health checkup for a CNC turning center in accordance with an embodiment of the present invention;

FIG. 2 shows a block diagram for an apparatus for performing an automatic health check-up for a CNC turning center by implementing the method illustrated in FIG. 1;

FIG. 3 illustrates exemplary system architecture for performing an automatic health check-up for a CNC turning center in accordance with an embodiment of the present invention; and

FIG. 4 illustrates a typical hardware configuration of a computer system, which is representative of a hardware environment for practicing the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

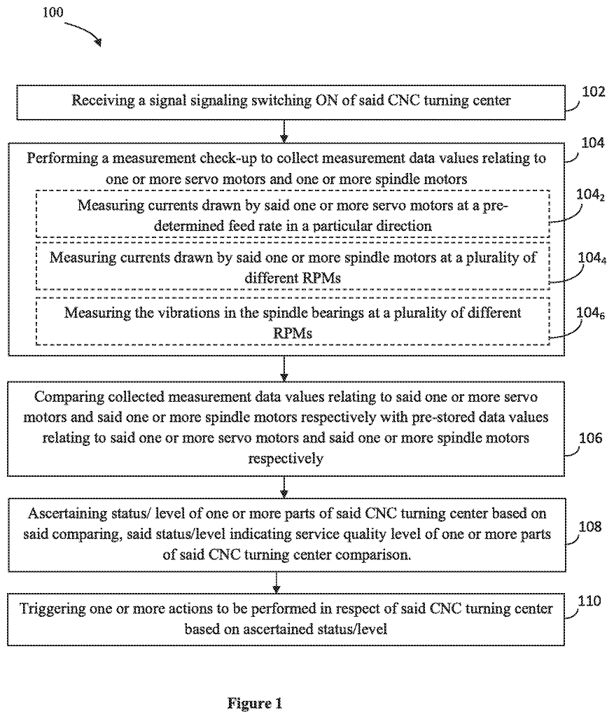

FIG. 1 illustrates a flowchart for a method 100 for performing an automatic healthcheck-up for a CNC turning center. The method 100 includes step 102 of receiving a signal signalling switching ON of said CNC turning center and step 104 of performing a measurement check-up to collect measurement data values relating to one or more servo motors and one or more spindle motors. The step 104 of performing includes step 1042 of measuring currents drawn by said one or more servo motors at a pre-determined feed rate in a particular direction; step 1044 of measuring currents drawn by said one or more spindle motors at a plurality of different RPMs; and step 1046 of measuring the vibrations in the spindle bearings at a plurality of different RPMs. The vibrations in the spindle bearings are measured using highly sensitive one or more vibration sensors; and currents drawn by the servo motors and spindle motors are measure using current measuring devices in their electric drive modules. The current measuring devices are standard devices including ammeter, multi meter etc. that are well known to a person skilled in the art. Vibrations are measured through a very sensitive accelerometer fitted above the front bearings of the spindle. By way of example, a standard CNC turning center is disclosed in EP patent application EP19860302884 entitled CNC Turning machine. The details of the same are incorporated herein by reference. The present application is however applicable to other CNC turning centres having servo axis motors and spindle (s).

The method 100 further includes step 106 of comparing collected measurement data values relating to said one or more servo motors and said one or more spindle motors respectively with pre-stored data values relating to said one or more servo motors and said one or more spindle motors respectively. The pre-stored data values correspond to current in servo motors, spindle motors and vibrations in spindle bearings that are calculated and stored under no load condition. Thereafter, the status/level of one or more parts of the CNC turning center based on comparison is ascertained is step 108, wherein status/level indicates service quality level of one or more parts of the CNC turning center. The step 108 of ascertaining involves analysing variation between the collected measurement data values relating to said one or more servo motors and one or more spindle motors respectively with pre-stored data values relating to said one or more servo motors and said one or more spindle motors respectively; and categorizing the status based on analysed variation. The analysis of variation involves analysing measured currents drawn by one or more servo motors at a predetermined feed rate, measured currents drawn by one or more spindle motors at plurality of different RPMs and measuring the vibrations in the spindle bearings at a plurality of different RPMs respectively individually or in any combination. Based on the on ascertained status/level, one or more actions to be performed in respect of said CNC turning center are triggered in step 110. The one or more actions action to be performed in respect of said CNC turning center includes one or more of: scheduling a time for maintenance of said CNC turning centre; automatic turning off the power of said CNC turning centre; disabling said CNC turning center completely until next maintenance; disabling said one or more parts of said CNC turning center until next maintenance; allowing said CNC turning centre to operate with one or more jobs.

In an embodiment, the one or more actions based on ascertained status/level are taken from a remote location.

In an embodiment, the ascertained status/level is transmitted to one or more cloud computing devices and/or an alarm is sounded in case the ascertained status/level is found to be beyond a permitted threshold level.

In an embodiment, step 102 of receiving signal signalling switching ON of the CNC turning center triggers one or more of:
moving both slides of X & Z Axis over a predetermined distance at a preset feed;
running said spindle without job at a plurality of varying preset speeds for a predetermined time.

In an embodiment, step 1042 of measuring of the currents drawn by the servo motors, step 1044 of measuring of the currents drawn by the spindle motor; and step 1046 of measuring of the vibrations in the spindle bearings take place simultaneously.

In an embodiment, step 1042 of measuring of the currents drawn by the servo motors, step 1044 of measuring of the currents drawn by the spindle motor; and step 1046 of measuring of the vibrations in the spindle bearings take place sequentially.

An exemplary implementation of the method referred above is described below. The present invention relies on a plurality of inputs to measure the health of the CNC turning center. The health in the present case refers to the condition of the Slideways (axis) and spindle assembly and of the overall CNC turning center. These inputs include a) Vibration b) Currents drawn by Servo motors & machine spindle. Whenever the CNC turning center is powered up, a health check-up mechanism is activated and a health check-up is thereafter performed for predefined instance of time 30 second. The time may be varied by the administrator. To avoid any accident, machine slides have to be brought into safe zone and job declamped. During the health check up, the currents drawn by the axis motors at a pre determined feed rate in a particular direction and also the spindle motor at two different RPM are measured. In addition the vibrations in the spindle bearings at the two different RPM are measured. In an exemplary implementation, both the slides are moved over a short distance at preset feed and the spindle (without job) is runs at 2 speeds (say 1000 & 2000 Rpm) for let's say 5 seconds each. During this period the currents drawn & vibrations are recorded. The measured current and vibration readings data are recorded and transmitted to a central server with date and time stamp for storage. In an embodiment, the central server includes a cloud computing device configured at a remote location. The sent data is sent to the compared to the pre-stored data values, referred to as Health Reference values. Generally, in a new machine with proper alignments & lubrication, no load current in servo motors depends on the mechanicals, direction & feed rate. If X axis is moved at 500 mm/min in +X direction, current (in percentage of max) will always be fixed (in a narrow band) e.g. 22-24%. Similarly for Spindle under no load running at 1000 Rpm, the current drawn may be 8-10% (say). Same for vibrations in spindle bearings. This value will vary from machine to machine but will be UNIQUE for any one machine and will be its ‘Health Reference’ and shall be stored. A threshold level shall also be stored that defines the upper limit for the workability of the machine. When the data is sent, a comparison Chart is generated which grades health of Spindle, X & Z axis as Excellent, Good, OK, NOT OK (Needs Maintenance in future) and BAD (Needs immediate stoppage and action). In case of BAD, machine is remotely disabled and Alarm on Screen reads: “Machine Stopped for IMMEDIATE health Check”. Based on the chart and the comparison, a message may be sent to the concerned Service Head of the region, Service Engineer in that area and the Central Support Engineer with details of the Health Chart. Based on the Health chart, appropriate action(s) may be taken. In an embodiment, appropriate action(s) is taken remotely.

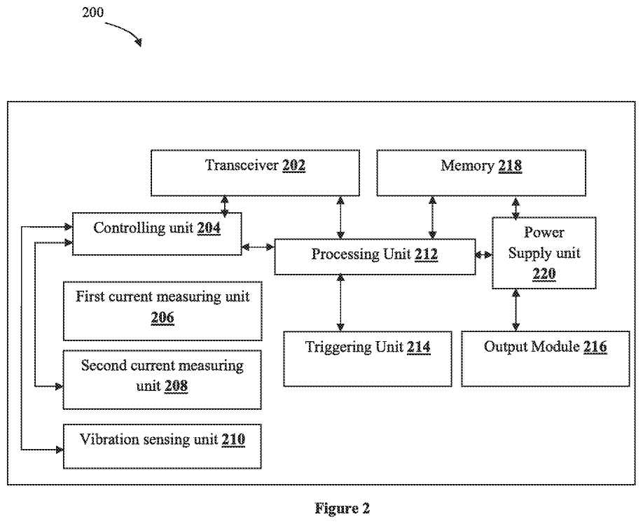

Referring to FIG. 2, an apparatus for performing an automatic health check-up for a CNC turning center using the method implemented in FIG. 1 is illustrated. The apparatus 200 includes a receiver 202 for receiving a signal signalling switching ON of said CNC turning center and a controlling unit 204 for performing a measurement check-up or configured to perform to collect measurement data values relating to one or more servo motors and one or more spindle motors. The apparatus 200 further includes first current measuring unit 206 for measuring currents drawn by said one or more servo motors at a predetermined feed rate in a particular direction, a second current measuring unit 208 for measuring currents drawn by said one or more spindle motors at a plurality of different RPMs; and a vibration sensing unit 210 for measuring the vibrations in the spindle bearings at a plurality of different RPMs. A processing unit 212 is further provided for comparing collected measurement data values relating to said one or more servo motors and said one or more spindle motors respectively with pre-stored data values relating to said one or more servo motors and said one or more spindle motors respectively; and ascertaining status/level of one or more parts of said CNC turning center based on said comparing, said status/level indicating service quality level of one or more parts of said CNC turning center. The apparatus 200 further includes a triggering unit 214 for triggering one or more actions to be performed in respect of said CNC turning center based on ascertained status/level.

The apparatus 200 further includes an output module 216 such as a display for displaying one or more of:
a. the measured current and vibrations;
b. details of variations between the measured current and vibrations respectively with the pre-set values;
c. details of appropriate actions to be taken based on the status.
d. log details pertaining to the measurement and comparison stored in memory 218.

In an embodiment, the system 200 further includes a power supply unit 220 for supplying power various components of the system 200.

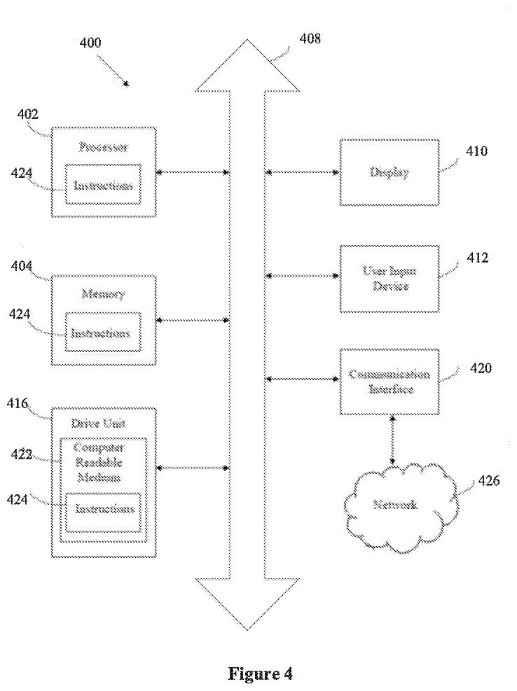

Referring to FIG. 4, an exemplary system architecture for performing an automatic health check-up for a CNC turning center in accordance with an embodiment of the present invention is illustrated. The system 300 essentially contains 3 major parts namely CNC machine 302, the SmartCheck device/Unit 304, and a remote server 306. The CNC machine 302 may be any CNC machine that is used in the industry. The CNC machine 302 contains CNC machines motors and drives 308, Current Values from Servo Axis and spindle drives Unit 310 that is responsible for detecting the current values from servo axis and spindle drive and storing thereof and Vibration Values from Spindle Unit 312 for handling the vibration values from the spindle and a CNC memory 314 for storing current and vibration values and other essential log data. Algorithms involved the CNC machine. The SmartCheck Unit 304 contains primary memory 316 for storing the details of the current and vibrations (measured by the vibration sensor 318). A control unit 420 is provided for storing the necessary algorithms for running the smart check unit and interconnecting with the CNC machine 302 and the remote server 306. The details are processed by the processor 422 and compared with the threshold and forwarded to the remote server 306 through the communication module 424 which are stored therein in the remote server memory/cloud 426. The remote server 306 further includes a display 428. Based on the processing by the processor 422, remote action may be taken from the from the remote server 306 using triggering device 330. The list of actions has been defined above in reference to earlier illustrated Figures.

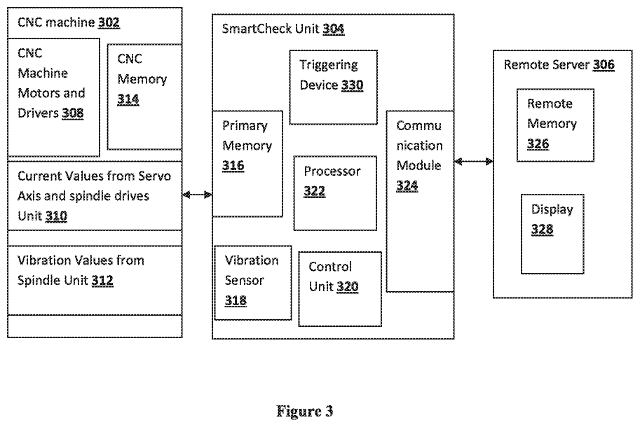

Referring to FIG. 3, a typical hardware configuration of a computer system, which is representative of a hardware environment for practicing the present invention, is illustrated. The computer system 400 can include a set of instructions that can be executed to cause the computer system 400 to perform any one or more of the methods disclosed. The computer system 400 may operate as a standalone device or may be connected, e.g., using a network, to other computer systems or peripheral devices.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system 400 is illustrated, the term “system” shall also be taken to include any collection of systems or sub-systems that individually or jointly execute a set, or multiple sets, of instructions to perform one or more computer functions.

The computer system 400 may include a processor 402 e.g., a central processing unit (CPU), a graphics processing unit (GPU), or both. The processor 402 may be a component in a variety of systems. For example, the processor may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analysing and processing data. The processor 402 may implement a software program, such as code generated manually (i.e., programmed).

The computer system 400 may include a memory 404, such as a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 404 includes a cache or random access memory for the processor 402. In alternative examples, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may or may not further include a display unit 410, such as a liquid crystal display (LCD), an organic light emitting diode (OLED), a flat panel display, a solid state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 416.

Additionally, the computer system 400 may include an input device 412 configured to allow a user to interact with any of the components of system 400. The input device 412 may be a number pad, a keyboard, or a cursor control device, such as a mouse, or a joystick, touch screen display, remote control or any other device operative to interact with the computer system 400.

The computer system 400 may also include a disk or optical drive unit 416. The disk drive unit 616 may include a computer-readable medium 422 in which one or more sets of instructions 424, e.g. software, can be embedded. Further, the instructions 424 may embody one or more of the methods or logic as described. In a particular example, the instructions 424 may reside completely, or at least partially, within the memory 404 or within the processor 402 during execution by the computer system 400. The memory 404 and the processor 402 also may include computer-readable media as discussed above.

The present invention contemplates a computer-readable medium that includes instructions 424 or receives and executes instructions 424 responsive to a propagated signal so that a device connected to a network 426 can communicate voice, video, audio, images or any other data over the network 426. Further, the instructions 424 may be transmitted or received over the network 426 via a communication port or interface 420 or using a bus 408. The communication port or interface 420 may be a part of the processor 402 or may be a separate component. The communication port 420 may be created in software or may be a physical connection in hardware. The communication port 420 may be configured to connect with a network 426, external media, the display 410, or any other components in system 400 or combinations thereof. The connection with the network 426 may be a physical connection, such as a wired Ethernet connection or may be established wirelessly as discussed later. Likewise, the additional connections with other components of the system 400 may be physical connections or may be established wirelessly. The network 426 may alternatively be directly connected to the bus 408.

The network 426 may include wired networks, wireless networks, Ethernet AVB networks, or combinations thereof. The wireless network may be a cellular telephone network, an 802.11, 802.16, 802.20, 802.1Q or WiMax network. Further, the network 426 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the system 400.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of embodiments. Those skilled in the art will appreciate that one or more of the described elements may well be combined into a single functional element. Alternatively, certain elements may be split into multiple functional elements.

Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for performing an automatic health check-up for a computerized numerical control (CNC) turning center, said method comprising the steps of:
receiving a signal signaling switching ON of said CNC turning center;
performing a measurement check-up to collect measurement data values relating to one or more servo motors and one or more spindle motors, wherein said performing includes:
measuring currents drawn by said one or more servo motors at a predetermined feed rate in a particular direction;
measuring currents drawn by said one or more spindle motors at a plurality of different Revolutions per minutes (RPM(s));
measuring the vibrations in the spindle bearings at a plurality of different RPMs;
comparing collected measurement data values relating to said one or more servo motors and said one or more spindle motors respectively with pre-stored data values relating to said one or more servo motors and said one or more spindle motors respectively;
ascertaining status/level of one or more parts of said CNC turning center based on said comparing, said status/level indicating service quality level of one or more parts of said CNC turning center;
triggering one or more actions to be performed in respect of said CNC turning centre based on ascertained status/level.

2. The method as claimed in claim 1, wherein said receiving of signal signaling switching ON of the CNC turning center triggers one or more of:
moving both slides of X & Z Axis over a predetermined distance at a preset feed;
running said spindle without job at a plurality of varying preset speeds for a predetermined time.

3. The method as claimed in claim 1, wherein said measuring of the currents drawn by the servo motors, said measuring of the currents drawn by the spindle motor; and said measuring of the vibrations in the spindle bearings takes place simultaneously or sequentially.

4. The method as claimed in claim 1, wherein said ascertaining involves:
a. analyzing variation between the collected measurement data values relating to said one or more servo motors and said one or more spindle motors respectively with pre-stored data values relating to said one or more servo motors and said one or more spindle motors respectively; and
b. categorizing the status based on analysed variation.

5. The method as claimed in claim 1, wherein said analysing of variation involves:
analysing measured currents drawn by said one or more servo motors at a predetermined feed rate, measured currents drawn by said one or more spindle motors at plurality of different RPMs and measuring the vibrations in the spindle bearings at a plurality of different RPMs respectively individually or in any combination.

6. The method as claimed in claim 1, wherein said one or more actions to be performed in respect of said CNC turning center includes one or more of:
scheduling a time for maintenance of said CNC turning centre;
automatic turning off the power of said CNC turning centre;
disabling said CNC turning center completely until next maintenance;
disabling said one or more parts of said CNC turning center until next maintenance;
allowing said CNC turning centre to operate with one or more jobs.

7. The method as claimed in claim 1, wherein said one or more actions based on ascertained status/level is taken from a remote location.

8. The method as claimed in claim 1 further comprising one or more of:
a. transmitting ascertained status/level to one or more cloud computing devices;
b. sounding an alarm in case the ascertained status/level is beyond a threshold level.

9. The method as claimed in claim 1, wherein:
vibrations in the spindle bearings are measured using highly sensitive one or more vibration sensors; and
currents drawn by the servo motors and spindle motors are measure using current measuring devices in their electric drive modules.

10. The method as claimed in claim 1, wherein pre-stored data values corresponding to current in servo motors, spindle motors and vibrations in spindle bearings are calculated and stored under no load condition.

11. An apparatus for performing an automatic health check-up for a CNC turning center, said apparatus comprising:
a transceiver for receiving a signal signalling switching ON of said CNC turning center;
a controlling unit configured to collect measurement data values relating to one or more servo motors and one or more spindle motors,
a first current measuring unit for measuring currents drawn by said one or more servo motors at a pre-determined feed rate in a particular direction;
a second current measuring unit for measuring currents drawn by said one or more spindle motors at a plurality of different RPMs;
a vibration sensing unit for measuring the vibrations in the spindle bearings at a plurality of different RPMs;
a processing unit for:
comparing collected measurement data values relating to said one or more servo motors and said one or more spindle motors respectively with pre-stored data values relating to said one or more servo motors and said one or more spindle motors respectively; and
ascertaining status/level of one or more parts of said CNC turning center based on said comparing, said status/level indicating service quality level of one or more parts of said CNC turning center; and
a triggering unit for triggering one or more actions to be performed in respect of said CNC turning center based on ascertained status/level.
